(19) United States
(12) Patent Application Publication
(10) Pub. No.: US 2024/0267870 A1
(43) Pub. Date: Aug. 8, 2024

(54) SYSTEMS AND METHODS FOR AI/ML WORKFLOW SERVICES AND CONSUMPTION IN O-RAN BY SMO NON-RT RIC

(71) Applicant: RAKUTEN MOBILE, INC., Tokyo (JP)

(72) Inventors: Pankaj SHETE, Tokyo (JP); Awn MUHAMMAD, Tokyo (JP)

(73) Assignee: RAKUTEN MOBILE, INC., Tokyo (JP)

(21) Appl. No.: 18/012,039

(22) PCT Filed: Oct. 12, 2022
(86) PCT No.: PCT/US2022/046363

§ 371 Date: Dec. 21, 2022

(51) Int. Cl. H04W 60/04

(52) U.S. Cl. CPC H04W 60/04

(57) ABSTRACT

A method performed in a processor executing a first application includes sending an application registration request to a second application provided in an open random access network (O-RAN) intelligent controller (RIC). The method further includes receiving, from the second application in response to the application registration request, a registration response including an application ID associated with the first application. The method further includes sending, to the second application, a register service request that includes at least (i) the application ID associated with the first application, and (ii) a service profile of a service provided by an artificial intelligence (AI) framework containing a plurality of learning models. The method further includes receiving, from the second application in response to the register service request, a register service response including a service identifier associated with the service provided by the AI framework.

### TECHNICAL FIELD

Apparatuses and methods consistent with example embodiments of the present disclosure relate to registering and subscribing to AI/ML workflow services the Open Radio Access Network (O-RAN) intelligent controller (RIC) platform.

### BACKGROUND

Machine learning is a field of study that provides computers the ability to learn without being explicitly programmed. O-RAN utilizes machine learning to learn useful information from input data and improve RAN or network performance. For example, the O-RAN architecture incorporates intelligent frameworks such as a near-real time O-RAN Intelligent Controller (Near-RT RIC) and a non-real time O-RAN Intelligent Controller (Non-RT RIC) for machine learning. These RICs contain rApps and xApps that enable ML models and data-driven decision making.

However, the access to Artificial Intelligence Machine Learning services are limited. Particularly, in the current O-RAN Specification, a procedure to subscribe to various phases of the AI/ML lifecycle as services through the Non-RT RIC, or through a service producer application (e.g., service producer rApp) communicating with a consumer application (e.g., consumer rApp) over a R1 interface is not specified. Improvements are presented herein. These improvements may also be applicable to other multi-access technologies and the telecommunication standards that employ these technologies.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Methods, apparatuses, and non-transitory computer-readable mediums for registering and subscribing to AI/ML workflow services the O-RAN intelligent controller (RIC) platform.

According to an exemplary embodiment, a method performed in a processor executing a first application includes sending an application registration request to a second application provided in an open random access network (O-RAN) intelligent controller (RIC). The method further includes receiving, from the second application in response to the application registration request, a registration response including an application ID associated with the first application. The method further includes sending, to the second application, a register service request that includes at least (i) the application ID associated with the first application, and (ii) a service profile of a service provided by an artificial intelligence (AI) framework containing a plurality of learning models. The method further includes receiving, from the second application in response to the register service request, a register service response including a service identifier associated with the service provided by the AI framework.

According to an exemplary embodiment, a method performed by a processor executing a first application external to an open random access network (O-RAN) intelligent controller (RIC) includes sending, to a second application provided in an O-RAN intelligent controller (RIC), a service discovery request. The method further includes receiving, from the second application in response to the service discovery request, a service discovery response including a list of services provided by an artificial intelligence (AI) framework containing a plurality of learning models. The method further includes sending, to a third application, a service subscriber request specifying a service included in the list of services. The method further includes receiving, from the third application in response to the service subscriber request, a service subscriber response providing information that enables the first application to use the service specified in the service subscriber request.

According to an exemplary embodiment, an apparatus executing a first application includes at least one memory configured to store computer program code, and at least one processor configured to access said at least one memory and operate as instructed by said computer program code. The computer program code includes first sending code configured to cause at least one of said at least one processor to send an application registration request to a second application provided in an open random access network (O-RAN) intelligent controller (RIC). The computer program code further includes first receiving code configured to cause at least one of said at least one processor to receive, from the second application in response to the application registration request, a registration response including an application ID associated with the first application. The computer program code further includes second sending code configured to cause at least one of said at least one processor to send, to the second application, a register service request that includes at least (i) the application ID associated with the first application, and (ii) a service profile of a service provided by an artificial intelligence (AI) framework containing a plurality of learning models. The computer program code further includes second receiving code configured to cause at least one of said at least one processor to receive, from the second application in response to the register service request, a register service response including a service identifier associated with the service provided by the AI framework.

According to an exemplary embodiment, an apparatus executing a first application external to an open random access network (O-RAN) intelligent controller (RIC) includes at least one memory configured to store computer program code, and at least one processor configured to access said at least one memory and operate as instructed by said computer program code. The computer program code further includes first sending code configured to cause at least one of said at least one processor to send, to a second application provided in an O-RAN intelligent controller (RIC), a service discovery request. The computer program further includes first receiving code configured to cause at least one of said at least one processor to receive, from the second application in response to the service discovery request, a service discovery response including a list of services provided by an artificial intelligence (AI) framework containing a plurality of learning models. The computer program code further includes second sending code configured to cause at least one of said at least one processor to send, to a third application, a service subscriber request specifying a service included in the list of services. The computer program code further includes second receiving code configured to cause at least one of said at least one processor to receive, from the third application in response to the service subscriber request, a service subscriber response providing information that enables the first application to use the service specified in the service subscriber request.

Additional embodiments will be set forth in the description that follows and, in part, will be apparent from the description, and/or may be learned by practice of the presented embodiments of the disclosure.

### BRIEF DESCRIPTION OF THE DRAWINGS

The above and other aspects, features, and aspects of embodiments of the disclosure will be apparent from the following description taken in conjunction with the accompanying drawings, in which:

FIG. 1 is a diagram of an example network device in accordance with various embodiments of the present disclosure.

FIG. 2 is a schematic diagram of an example O-RAN communications system, in accordance with various embodiments of the present disclosure.

FIG. 3 illustrates an example mapping relationship between machine learning components and network functions, in accordance with various embodiments of the present disclosure.

FIG. 4 illustrates an example non-real time O-RAN Intelligent Controller (RIC) architecture, in accordance with various embodiments of the present disclosure.

FIG. 5 illustrates an example sequence diagram of a service registration process, in accordance with various embodiments of the present disclosure.

FIG. 6 illustrates an example sequence diagram of a service discovery and subscription process, in accordance with various embodiments of the present disclosure.

FIG. 7 illustrates an example sequence diagram of a service registration process, in accordance with various embodiments of the present disclosure.

FIG. 8 illustrates an example sequence diagram of a service discovery and subscription process, in accordance with various embodiments of the present disclosure.

FIG. 9 illustrates an example sequence diagram of a service discovery and subscription process, in accordance with various embodiments of the present disclosure.

FIG. 10 illustrates an example flow chart of a service registration process, in accordance with various embodiments of the present disclosure.

FIG. 11 illustrates an example flow chart of a service discovery and subscription process in accordance with embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Embodiments of the present disclosure are directed to providing various phases of an AI/ML lifecycle as services. For example, the embodiments of the present disclosure enable AI/ML services to be accessed through the Non-RT RIC framework, through a service producer application (e.g., service producer rApp), or through both the service producer application and a consumer application (e.g., consumer rApp) communicating over a R1 interface for usage of an AI/ML model in relation with a specific ML-assisted solution (e.g., use cases) to be executed by the consumer application. Embodiments of the present disclosure define procedures to access various phases of an AI/ML lifecycle as services through the Non-RT RIC framework or through the service producer rApp communicating with the consumer rApp over a R1 interface. Therefore, various phases of AI/ML lifecycles may be advantageously used in the O-RAN framework by the consumer rApp.

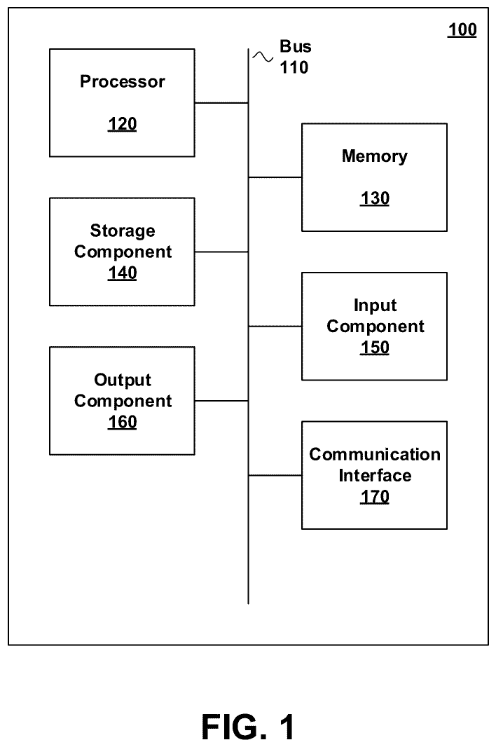

FIG. 1 is a diagram of an example device 100 for implementing the methods of the present disclosure. Device 100 may implement any of the rApps disclosed herein, as well as the O-RAN RIC, and the AI/ML framework. Device 100 may correspond to any type of known computer, server, or data processing device. For example, the device 100 may comprise a processor, a personal computer (PC), a printed circuit board (PCB) comprising a computing device, a mini-computer, a mainframe computer, a microcomputer, a telephonic computing device, a wired/wireless computing device (e.g., a smartphone, a personal digital assistant (PDA)), a laptop, a tablet, a smart device, or any other similar functioning device.

In some embodiments, as shown in FIG. 1, the device 100 may include a set of components, such as a processor 120, a memory 130, a storage component 140, an input component 150, an output component 160, and a communication interface 170.

The bus 110 may comprise one or more components that permit communication among the set of components of the device 100. For example, the bus 110 may be a communication bus, a cross-over bar, a network, or the like. Although the bus 110 is depicted as a single line in FIG. 1, the bus 110 may be implemented using multiple (two or more) connections between the set of components of device 100. The disclosure is not limited in this regard.

The device 100 may comprise one or more processors, such as the processor 120. The processor 120 may be implemented in hardware, firmware, and/or a combination of hardware and software. For example, the processor 120 may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The processor 120 also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The processor 120 may control overall operation of the device 100 and/or of the set of components of device 100 (e.g., the memory 130, the storage component 140, the input component 150, the output component 160, the communication interface 170).

The device 100 may further comprise the memory 130. In some embodiments, the memory 130 may comprise a random access memory (RAM), a read only memory (ROM), an electrically erasable programmable ROM (EEPROM), a flash memory, a magnetic memory, an optical memory, and/or another type of dynamic or static storage device. The memory 130 may store information and/or instructions for use (e.g., execution) by the processor 120.

The storage component 140 of device 100 may store information and/or computer-readable instructions and/or code related to the operation and use of the device 100. For example, the storage component 140 may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

The device 100 may further comprise the input component 150. The input component 150 may include one or more components that permit the device 100 to receive information, such as via user input (e.g., a touch screen, a keyboard, a keypad, a mouse, a stylus, a button, a switch, a microphone, a camera, and the like). Alternatively or additionally, the input component 150 may include a sensor for sensing information (e.g., a global positioning system (GPS) component, an accelerometer, a gyroscope, an actuator, and the like).

The output component 160 of device 100 may include one or more components that may provide output information from the device 100 (e.g., a display, a liquid crystal display (LCD), light-emitting diodes (LEDs), organic light emitting diodes (OLEDs), a haptic feedback device, a speaker, and the like).

The device 100 may further comprise the communication interface 170. The communication interface 170 may include a receiver component, a transmitter component, and/or a transceiver component. The communication interface 170 may enable the device 100 to establish connections and/or transfer communications with other devices (e.g., a server, another device). The communications may be effected via a wired connection, a wireless connection, or a combination of wired and wireless connections. The communication interface 170 may permit the device 100 to receive information from another device and/or provide information to another device. In some embodiments, the communication interface 170 may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface 170 may provide for communications with another device via a device-to-device (D2D) communication link, such as FlashLinQ, WiMedia, Bluetooth, ZigBee, Wi-Fi, LTE, 5G, and the like. In other embodiments, the communication interface 170 may include an Ethernet interface, an optical interface, a coaxial interface, an infrared interface, a radio frequency (RF) interface, or the like.

The device 100 may be included in the core network 240 and perform one or more processes described herein. The device 100 may perform operations based on the processor 120 executing computer-readable instructions and/or code that may be stored by a non-transitory computer-readable medium, such as the memory 130 and/or the storage component 140. A computer-readable medium may refer to a non-transitory memory device. A memory device may include memory space within a single physical storage device and/or memory space spread across multiple physical storage devices.

Computer-readable instructions and/or code may be read into the memory 130 and/or the storage component 140 from another computer-readable medium or from another device via the communication interface 170. The computer-readable instructions and/or code stored in the memory 130 and/or storage component 140, if or when executed by the processor 120, may cause the device 100 to perform one or more processes described herein.

Alternatively or additionally, hardwired circuitry may be used in place of or in combination with software instructions to perform one or more processes described herein. Thus, embodiments described herein are not limited to any specific combination of hardware circuitry and software.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally or alternatively, a set of (one or more) components shown in FIG. 1 may perform one or more functions described as being performed by another set of components shown in FIG. 1.

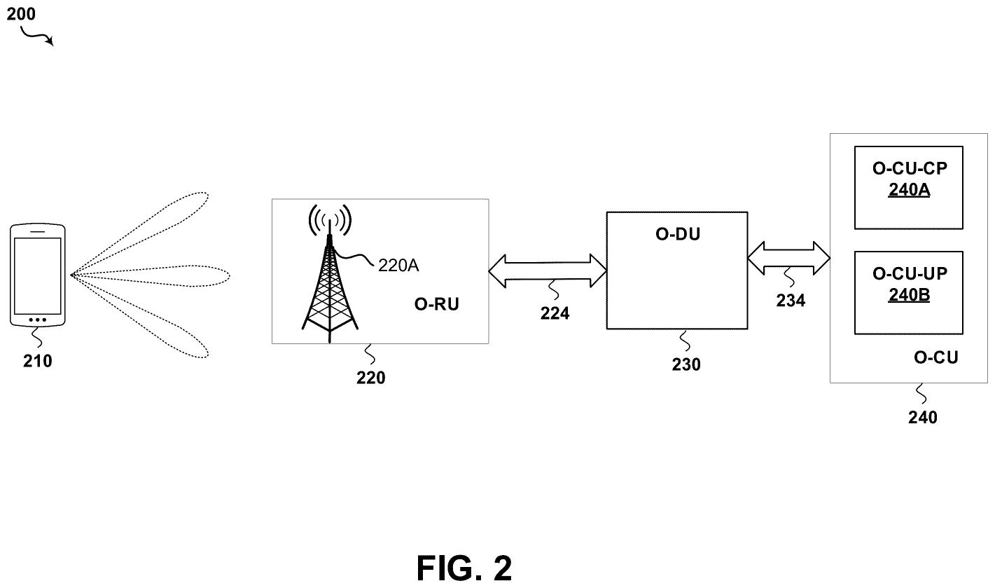

FIG. 2 is a diagram illustrating an example O-RAN communication system 200, according to various embodiments of the present disclosure. The O-RAN communication system 200 may include one or more user equipment (UE) 210, one or more O-RAN Radio Units (O-RU) 220 that includes one or more base stations 220a, one or more O-RAN Distribution Units (O-DU) 230, and one or more O-RAN Centralized Units (O-CU) 240.

Examples of UEs 210 may include a cellular phone, a smart phone, a session initiation protocol (SIP) phone, a laptop, a personal digital assistant (PDA), a satellite radio, a global positioning system (GPS), a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similarly functioning device. Some of the one or more UEs 210 may be referred to as Internet-of-Things (IoT) devices (e.g., parking meter, gas pump, toaster, vehicles, heart monitor, etc.). The one or more UEs 210 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile agent, a client, or some other suitable terminology.

The one or more base stations 220A of the O-RU 220 may wirelessly communicate with the one or more UEs 210. Each base station of the one or more base stations 220A may provide communication coverage to one or more UEs 210 located within a geographic coverage area of that base station 220A. In some embodiments, as shown in FIG. 2, the base station 220A may transmit one or more beamformed signals to the one or more UEs 210 in one or more transmit directions. The one or more UEs 210 may receive the beamformed signals from the base station 220A in one or more receive directions. Alternatively or additionally, the one or more UEs 210 may transmit beamformed signals to the base station 220 in one or more transmit directions. The base station 220A may receive the beamformed signals from the one or more UEs 210 in one or more receive directions.

The one or more base stations 220A may include macrocells (e.g., high power cellular base stations) and/or small cells (e.g., low power cellular base stations). The small cells may include femtocells, picocells, and microcells. A base station 220A, whether a macrocell or a large cell, may include and/or be referred to as an access point (AP), an evolved (or evolved universal terrestrial radio access network (E-UTRAN)) Node B (eNB), a next-generation Node B (gNB), or any other type of base station known to one of ordinary skill in the art.

In some embodiments, the O-RU 220 may be connected to the O-DU 230 via a FH link 224. The FH link 224 may be a 25 Gbps line in which User Plane (U-plane) and Control Plane (C-Plane) packets are downloaded from the O-DU 230 to the O-RU 220. In some embodiments, the O-DU 230 may be connected to the O-CU 240 via a midhaul link 234. The O-CU 240 may include an O-CU Control Plane (O-CU-CP) packet generator 240A and an O-CU User Plane (O-CU-UP) packet generator 240B. C-plane and U-plane packets may originate from the O-CU-CP packet generator 240A and the O-CU-UP packet generator 240B, respectively.

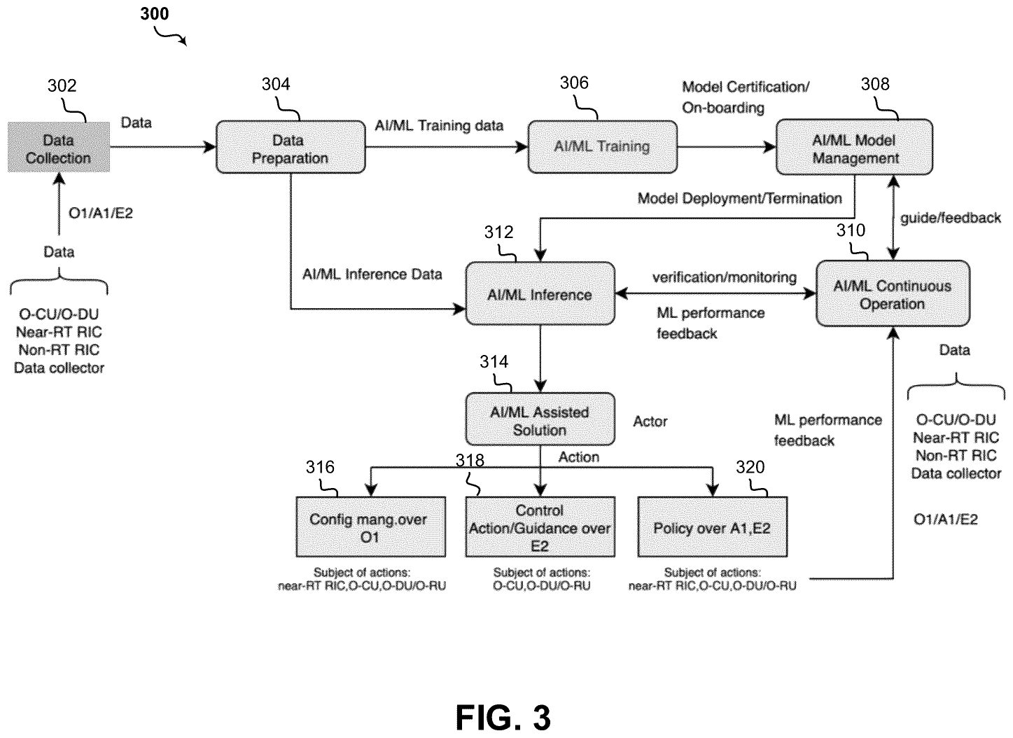

FIG. 3 illustrates an example mapping relationship between machine learning (ML) components and O-RAN network functions and interfaces for various stages of an AI/ML life cycle. The O-RU, O-DU, and O-CU referenced in FIG. 3 may correspond to the O-RU 220, O-DU 230, and O-CU 240 (FIG. 2), respectively.

In some embodiments, the Data Collection function 302 may collect data for training a ML model as an initial step in the ML pipeline. This process may avoid some of the problems related to data such as unrelated data, missing data, data bias and imbalance, etc. In some embodiments, the Data Preparation function 304 may transform raw data to enable the data to be run through machine learning algorithms to uncover insights or make predictions. Real-world raw data may be incomplete, inconsistent, and lacking in certain behaviors or trends. Real-world raw data may also contain many errors. Therefore, after the Data Collection function 302 is performed, the Data Preparation function 304 may pre-process the collected raw data into a format usable by a machine learning algorithm.

In some embodiments, the AI/ML Training function 306 may include training ML models with available data. The training process may be monitored to determine whether the process is converged or collect key information, such as memory used, loss, accuracy, etc. In some embodiments, the AI/ML Model Management function 308 may manage models that are onboarded directly from a ML training host or those from a ML compiling host when model compiling is executed after training.

In some embodiments, the AI/ML Inference function 310 may include a model inference engine that parses model files, splits operations, and executes an inference instruction stream to finish a ML model inference calculation and return an inference result. The AI/ML Continuous Operation function 312 may provide a series of online functionalities for the continuous improvement of AI/ML models within the whole AI/ML lifecycle. This function may include verification/monitoring/analysis/recommendation/continue optimization.

In some embodiments, the AI/ML Assisted Solution function 314 may addresses a specific use case using Machine-Learning algorithms during operation. Traffic steering using ML is an example ML-assisted solution. This function may perform configuring management over an O1 interface 316, control action/guidance over an E2 interface 318, or controlling policy over a A1 or E2 interface 320.

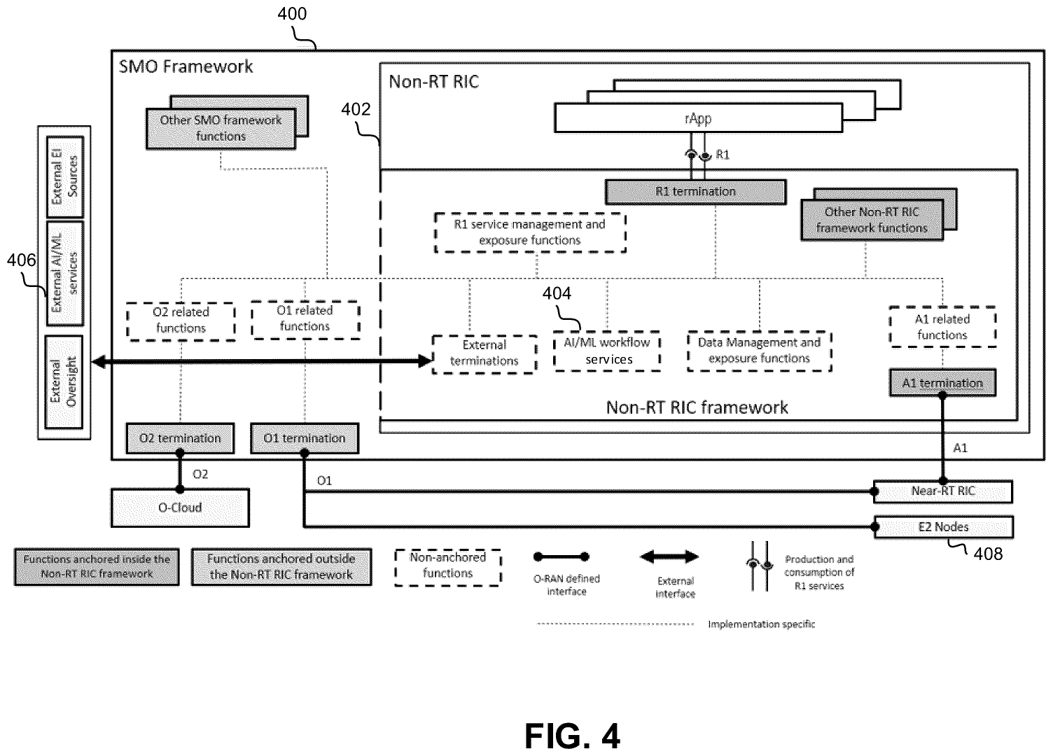

FIG. 4 illustrates an example Service Management Orchestration (SMO) framework 400 and a non-RT RIC architecture 402. In some embodiments, as shown in FIG. 4, the AI/ML workflow services 404 may be part of the SMO/Non-RT RIC, indicating that the SMO/Non-RT RIC will manage data collection and preparation, model building, model training, model deployment, model execution, model validation, continuous model self-monitoring and self-learning/retraining related to ML-assisted solutions, etc. External AI/ML services 406 may correspond to the AI/ML services provided by the AI/ML framework, which is external to the SMO framework 400. The E2 Nodes 408 may include the O-DU 230, O-CU-CP 240A, and O-CU-UP 240B (FIG. 2).

AI/ML workflow services may provide key phases or functionalities of AI/ML lifecycle to the consumer rApp to use AI/ML for its analysis or decision-making purpose. AI/ML workflow services included in the ORAN framework include, but are not limited to, ML model and inference hosting services, AI/ML model training and hosting services, AI/ML model repository services, and AI/ML model management services.

In some embodiments, a rApp or Non-RT RIC framework or Near-RT RIC or any external entity shall provide model inference host information after ML Model Discovery. AI/ML Workflow services & exposure functionality may request for inference host capability information from a rApp or Non-RT RIC framework or Near-RT RIC or any external entity (i.e., where inference will be hosted).

In some embodiments, AI/ML model training and hosting services may include one or more services such as 1) training host capability check, 2) starting or terminating model training, and 3) validation of trained models and publishing. The training host capability check service may include ML/DL framework (e.g., pytorch, tensorflow, caffe, etc.), data format of input and output, requirements on model performance (e.g., accuracy, responding time, real-time factor, etc.), model footprint and HW platform (e.g., ARM, GPU, CPU, FPGA, etc.), and task requirements.

In some embodiments, the AI/ML model repository service may include ML model discovery, ML model registration, ML model deletion, ML model deregistration, and ML model retrieval. ML model discovery may enable a rApp to request for available ML models from a model inventory inside the Non-RT RIC framework or outside of the Non-RT RIC through external termination or through another rApp (e.g., service producer rApp) over a R1 interface.

ML model registration may enable a service producer to register ML models with metadata in prescribed format such as 1) version of model, 2) size of models (e.g., MB or GB, etc.), 3) compute requirement (e.g., GFLOPs or TFLOPS), 4) training details such as duration of training, last training timestamp, 5) model training metrics (e.g., classification accuracy, logarithmic loss, confusion matrix, area under curve, F1 score, mean absolute error, mean squared error), 6) hyperparameters used for training the model, predicted outcomes, and 7) diagnostic charts (e.g., confusion matrix, ROC curves). The hyperparameters may include learning rate in optimization algorithms (e.g., gradient descent), choice of optimization algorithm (e.g., gradient descent, stochastic gradient descent, or Adam optimizer), choice of cost or loss function the model will use, number of clusters in a clustering task, pooling size, and batch size.

The ML model deletion may allow a service consumer application to delete a version of a stored ML model. The ML model deregistration may allow a service consumer application to deregister a stored ML model (e.g., all stored versions of the model are removed).

In some embodiments, the AI/ML model management services may manage the ML models to be deployed in the inference host, and may provide services including 1) maintaining, publishing health and state of ML model during inferencing, 2) certification and onboarding of models, 3) deployment, management, and termination of models, 4) activation and inferencing of model, 5) ML model feedback such as performance of model, 6) ML model retraining update, and 7) ML model reselection.

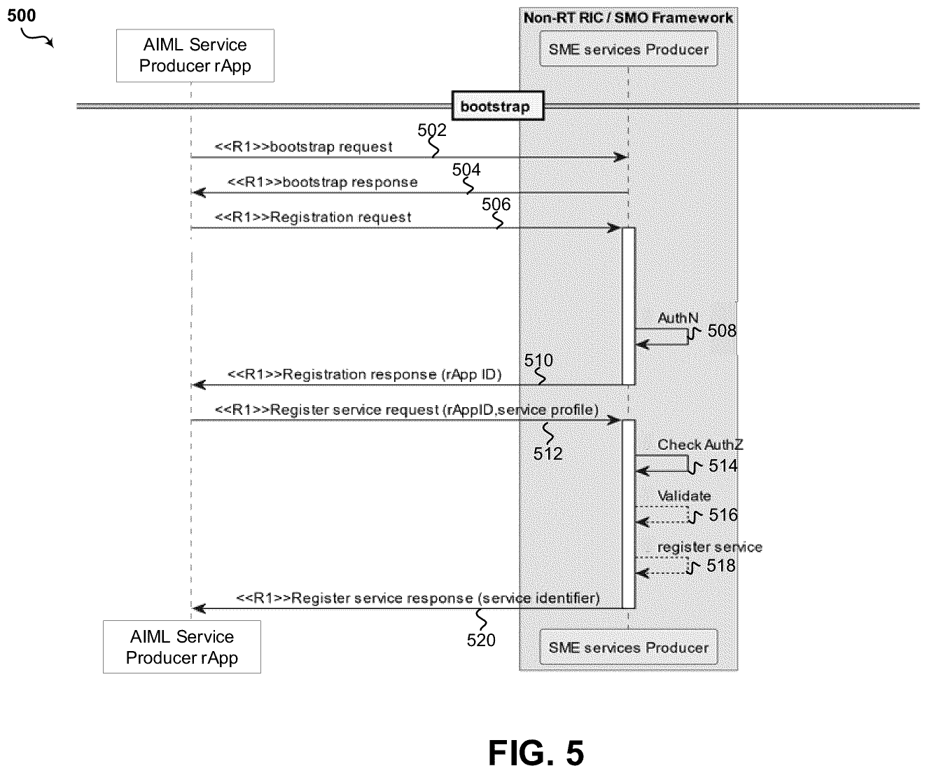

In some embodiments, to provide AI/ML workflow services, a rApp may register services provided as a service producer to the Non-RT RIC platform function (e.g., service management & exposure function (SME)), where a consumer rApp may subscribe to the registered services. FIG. 5 illustrates an example sequence diagram of a service registration process 500, in accordance with various embodiments of the present disclosure. The process 500 may be performed between an AI/ML service producer rApp and a SME services producer app. As illustrated in FIG. 5, the AI/ML service producer rApp is external to the SMO framework, and the SME services producer rApp is located within the SMO framework and/or the Non-RT RIC platform. The process 500 may provide registration of an AI/ML rApp as a service producer. For example, the AI/ML service producer rApp may be an rApp provided on an AI/ML framework that is external to the SMO Framework and Non-RT RIC.

The process may start at step 502 where the AI/ML service producer rApp sends a bootstrap request to the SME services producer. In some embodiments, the bootstrap service may provide discovery of a rApp registration Application Programming Interface (API) to enable the AI/ML service producer rApp to communicate with the SME services producer. At step 504, the SME services producer provides a bootstrap response, which may include information regarding the rApp registration API.

At step 506, the AI/ML service producer rApp sends a registration request to the SME services producer. To register an rApp, the AI/ML service producer app may pass information including the rApp name, vendor, software version, and other information needed by the Non-RT RIC/SMO framework. At step 508, the SME services producer authenticates the AI/ML service producer rApp. At step 510, in response to a successful authentication, the SME services producer sends a registration response that may include an application ID such as the rApp ID. The application ID may be an ID uniquely associated with the AI/ML service producer rApp so that the SME services producer may recognize any particular rApp sending messages to the SME services producer. If the authentication is not successful, the registration response may include a message indicating a failed authentication.

At step 512, the AI/ML service producer rApp sends a register service request to the SME services producer. The register service request may include the application ID provided at step 510 and service profiles of one or more services to be registered with the SME services producer. The service profiles of the one or more services may correspond to the aforementioned AI/ML workflow services. At step 514, each service profile is authenticated. Step 514 may be a request from the rApp. At step 516, each service profile is validated. For example, the framework may check the service profile along with the rApp ID. At step 518, each authenticated and validated service profile is registered with the SME services producer. At step 520, the SME services producer sends to the AI/ML service producer rApp a register service response, which may include a service identifier for each registered service profile. The service identifier may be used to discover service endpoints.

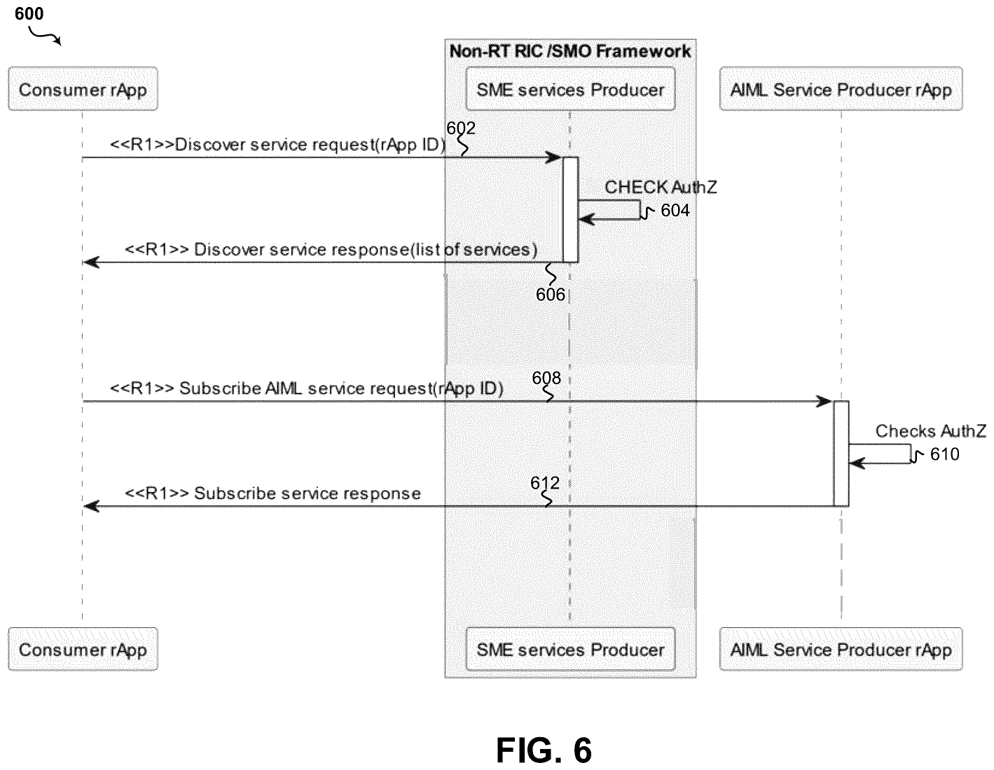

FIG. 6 illustrates an example sequence diagram of a service discovery and subscription process 600, in accordance with various embodiments of the present disclosure. In some embodiments, the process 600 illustrates a consumer rApp communicating with the SME services producer and the AI/ML service producer rApp to subscribe to AI/ML services.

The process 600 may start at step 602 where the consumer rApp sends a service discovery request to the SME services producer. The service discovery request may be used to discover available AI/ML services at SME. As an example, the available services may correspond to the services of the service profiles registered with the SME services producer in process 500 (FIG. 5). The service discovery request may include an application ID such as an rApp ID. The service discovery request may include selection criteria information such as name of the service (e.g., AI/ML services), service type, service capabilities (e.g., requirement to consume those services), etc.

At step S604, the SME services producer authenticates the service discovery request. In response to a successful authentication, the SME services producer sends a service discovery response at step 606. The service discovery response may include a list of services. As an example, the list of services may include all registered services with the SME services producer. As another example, the list of services may include services that match selection criteria specified in the service discovery request. The service discovery response may include endpoint information and service identifiers of each service specified in the list of services.

At step 608, the consumer rApp sends a service subscription request to the AI/ML services producer rApp. The service subscription request may include the rApp ID and service identifiers of each service to which the consumer rApp is subscribing. At step 610, the AI/ML services producer rApp authenticates the service subscription request. In response to a successful authentication, the AI/ML service producer rApp sends a subscription service response to the consumer rApp at step 612. The subscription service response may include a subscription ID for each subscribed service. The subscription service response may further include procedures and endpoints to use a subscribed service and sub services of the subscribed service. The subscription service response may further include capability info for each subscribed service. Accordingly, based on processes 500 and 600, the consumer rApp is advantageously able to subscribe to services provided by an AI/ML framework that are otherwise inaccessible.

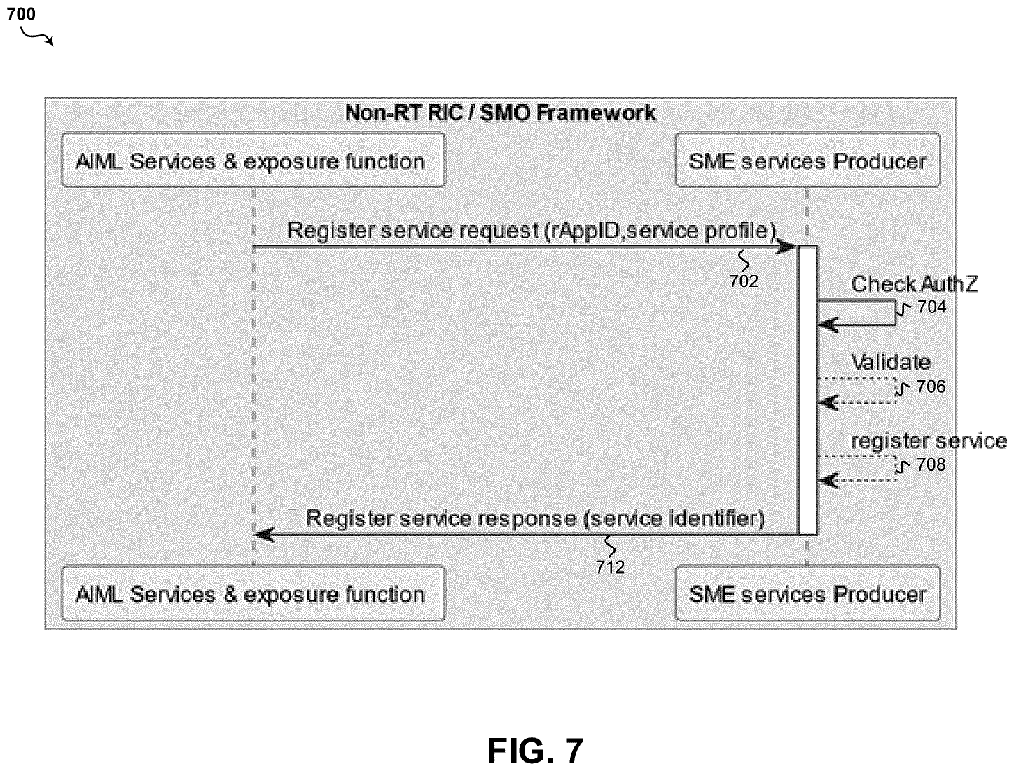

FIG. 7 illustrates an example sequence diagram of a service registration process 700, in accordance with various embodiments of the present disclosure. Compared to the service registration process 500, where the AI/ML service producer rApp is external to the SMO framework and the Non-RT RIC, the process 700 is performed between two applications included within the SMO framework. For example, the process 700 may be performed between a AI/ML services and exposure function app and the SME services producer app to register AI/ML services provided by an AI/ML framework. At step 702, the AI/ML services and exposure function app sends a register service request to the SME services producer similar to step 512. The SME services producer step performs an authentication step 704, a validation step 706, and a register service step 708, similar to steps 514, 516, and 518, respectively. At step 712, the SME services producer sends a register service response similar to step 520.

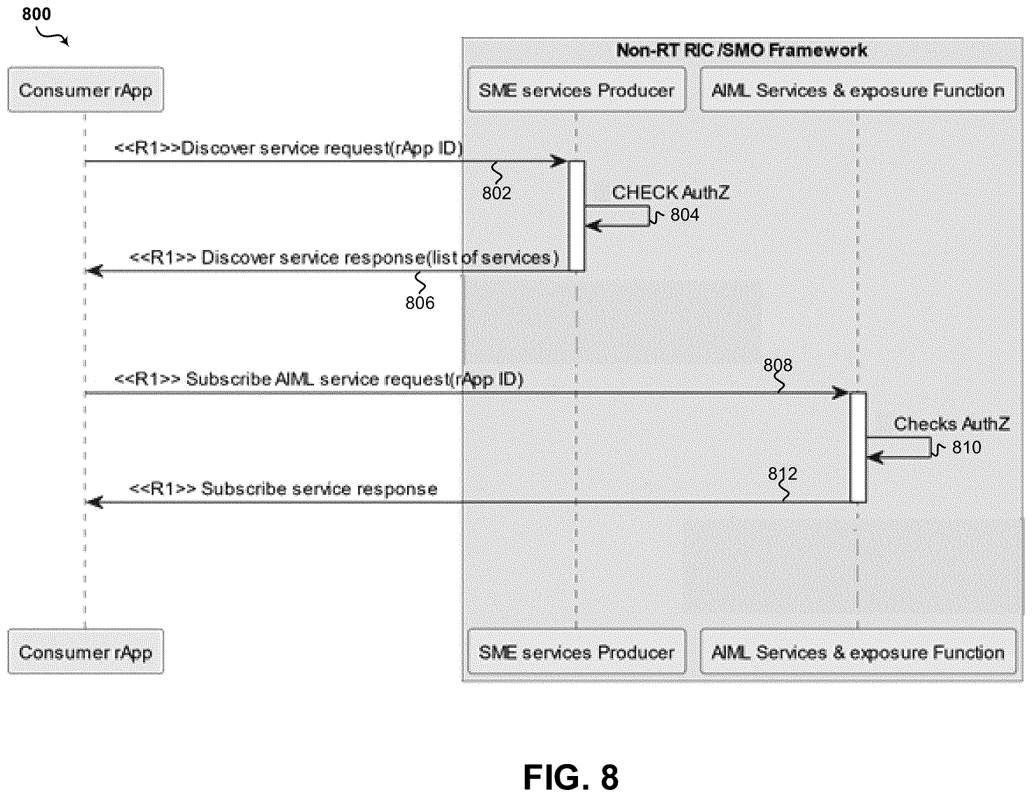

FIG. 8 illustrates an example sequence diagram of a service discovery and subscription process 800, in accordance with various embodiments of the present disclosure. The process 800 may be based on the registration of services performed in process 700. At step 802, the consumer rApp sends a service discovery request to the SME services producer similar to step 602. At step 804, the SME services producer authenticates the service discovery request similar to step 804. At step 806, the SME services producer sends a service discovery response similar to step 606. At step 808, the consumer rApp sends a service subscription request to the AI/ML services and exposure function similar to step 608. At step 810, the AI/ML services and exposure function authenticates the service subscription request similar to step 610. At step 812, the AI/ML services and exposure function sends a subscription service response similar to step 612.

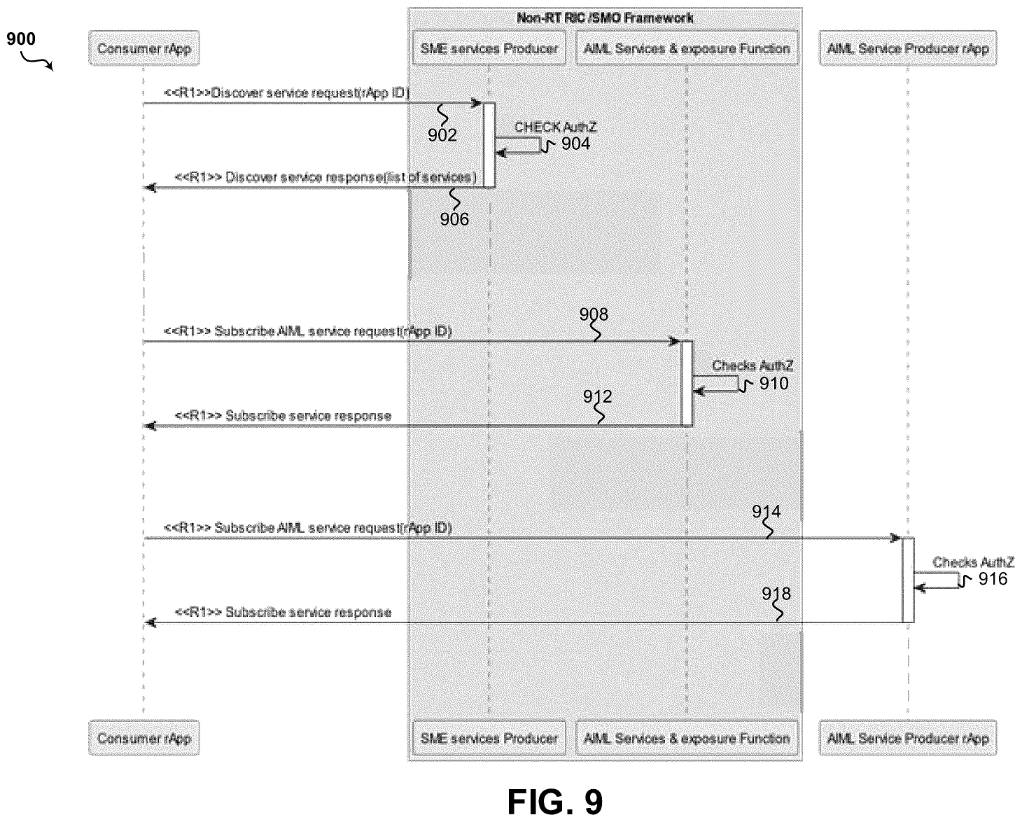

FIG. 9 illustrates an example sequence diagram of a service discovery and subscription process 900, in accordance with various embodiments of the present disclosure. The process 900 may be performed between a consumer rApp communicating with a SME services producer, an AI/ML services and exposure function, and an AI/ML service producer rApp. The process 900 may be performed based on the registration processes 500 and 700.

The process 900 may start at step 902 where the consumer rApp sends a service discovery request to the SME services producer similar to step 602. At step 904, the SME services producer may authenticate the service discovery request similar to step 604. At step 906, the SME services producer may send a service discovery response to the consumer rApp similar to step 606.

At step 908, the consumer rApp sends a service subscription request to the AI/ML services and exposure function similar to step 808. At step 910, the AI/ML services and exposure function authenticates the service subscription request similar to step 810. At step 912, the AI/ML services and exposure function sends a subscription service response similar to 812.

At step 914, the consumer rApp sends a subscription service request to the AI/ML service producer rApp 914 similar to step 608. At step 916, the AI/ML service producer rApp authenticates the subscription service request similar to step 610. At step 918, the AI/ML service producer rApp sends a subscription service response similar to step 612. While process 600 is directed to subscribing services only from the producer rApp, and process 800 is directed to subscribing services only from the AIML Service and exposure function, process 900 is directed to subscribing services from both the rApp and the AIML and exposure function.

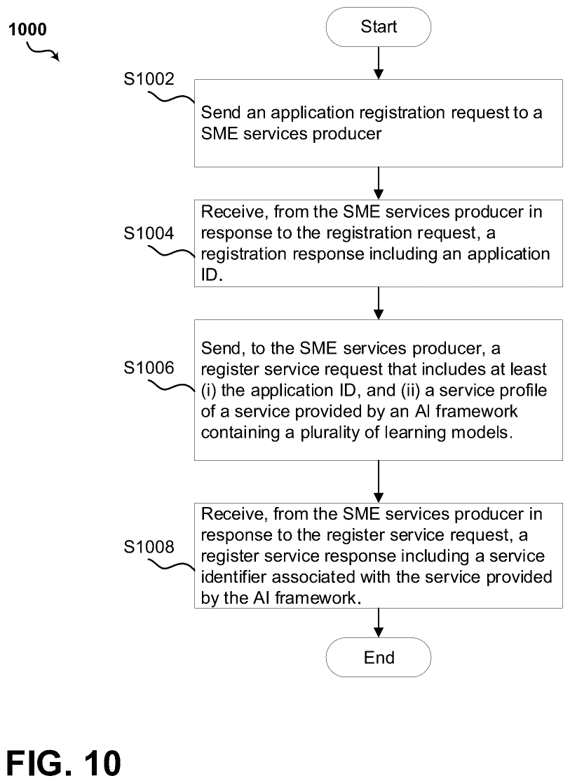

FIG. 10 illustrates an example flow chart of an embodiment of a service registration process 1000. The process 1000 may be performed by a device 100 (FIG. 1) executing the AI/ML service producer rApp or the AI/ML services and exposure function. The process 1000 may generally start at step S1002 where an application registration request is sent to a SME service producer. The process proceeds to step S1004 where, in response to the registration request, a registration response is received from the SME services producer. The registration response may include an application ID. The application ID may be a rApp ID.

The process proceeds to step S1006, where a register service request is sent to the SME services producer. The register service request may include at least the application ID and a service profile of a service provided by an AI framework containing a plurality of learning models. The AI framework may correspond to the AI/ML framework. The process proceeds to step S1008 where a register service response is received from the SME services producer in response to the register service request. The register service response may include a service identifier associated with the service provided by the AI framework. The process 1100 may terminate after step S1008.

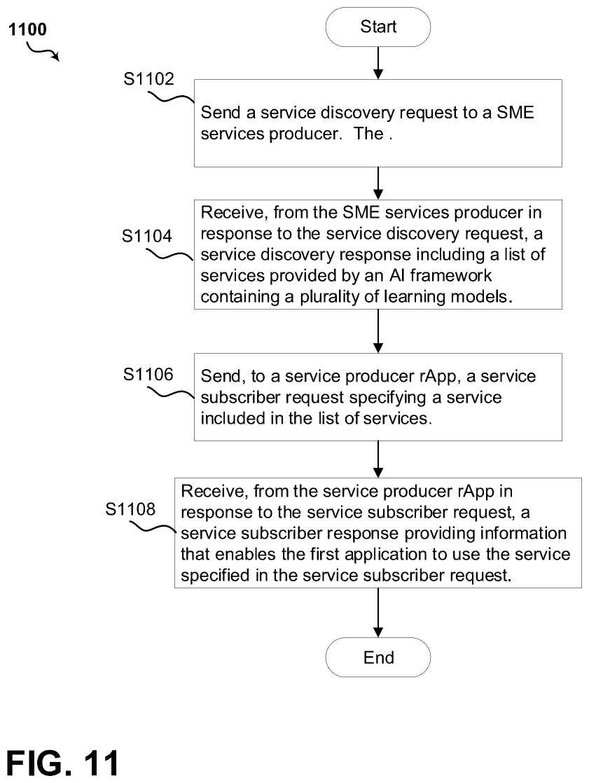

FIG. 11 illustrates an example flow chart of an embodiment of a service discovery and subscription process 1100. The process 1100 may be performed by device 100 executing a consumer rApp. The process 1100 may generally start at step S1102 where a service discovery request is sent to a SME services producer. The service discovery request may include an application ID. The service discovery request may also include selection criteria specifying criteria for selecting a service. The process proceeds to step S1104 where a service discovery response is received from the SME services producer in response to the service discovery request. The service discovery response may include a list of services provided by an AI framework containing a plurality of learning models. The list of services may be selected in accordance with the selection criterion.

The process proceeds to step S1106, where a service subscriber request is sent to a service producer rApp. The service subscriber request may specify a service included in the list of services. The process proceeds to step S1108, where a service subscriber response is received from the service producer rApp in response to the service subscriber request. The service subscriber response may include information that enables the consumer rApp to use the service specified in the service subscriber request such as service endpoints. The process 1100 may terminate after step S1108.

The foregoing disclosure provides illustration and description, but is not intended to be exhaustive or to limit the implementations to the precise form disclosed. Modifications and variations are possible in light of the above disclosure or may be acquired from practice of the implementations.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

The above disclosure also encompasses the embodiments listed below:

(1) A method performed in a processor executing a first application, the method includes sending an application registration request to a second application provided in an open random access network (O-RAN) intelligent controller (RIC); receiving, from the second application in response to the application registration request, a registration response including an application ID associated with the first application: sending, to the second application, a register service request that includes at least (i) the application ID associated with the first application, and (ii) a service profile of a service provided by an artificial intelligence (AI) framework containing a plurality of learning models; and receiving, from the second application in response to the register service request, a register service response including a service identifier associated with the service provided by the AI framework.

(2) The method of feature (1), further including receiving, from a third application external to the RIC, a subscription request including the service identifier associated with the service provided by the AI framework; and sending, to the third application in response to the subscription request, a subscription response including at least service endpoints that enable the third application to use the service provided by the AI framework.

(3) The method of feature (1) or (2), in which the first application is external to the RIC, and the first application communicates with the second application via an O-RAN R1 interface.

(4) The method of feature (3), further including: prior to sending the application registration request, sending a bootstrap request to the second application; and receiving, from the second application, a bootstrap response including information regarding an application registration application programming interface (API).

(5) The method according to any one of features (1) -(4), in which the service provided by the AI framework is one of a (i) model and inference hosting service, (ii) model training and hosting service, (iii) model repository service, or (iv) a model management service.

(6) A method performed by a processor executing a first application external to an open random access network (O-RAN) intelligent controller (RIC), the method including: sending, to a second application provided in an O-RAN intelligent controller (RIC), a service discovery request: receiving, from the second application in response to the service discovery request, a service discovery response including a list of services provided by an artificial intelligence (AI) framework containing a plurality of learning models; sending, to a third application, a service subscriber request specifying a service included in the list of services; and receiving, from the third application in response to the service subscriber request, a service subscriber response providing information that enables the first application to use the service specified in the service subscriber request.

(7) The method of feature (6), in which the list of services included in the service discovery response includes capability information of each service included in the list of services.

(8) The method of feature (6) or (7), in which the information that enables the first application to use the service specified in the service subscriber request includes one or more procedures regarding the use of the service.

(9) The method according to any one of features (6) -(8), in which the information that enables the first application to use the service specified in the service subscriber request includes end points of the service in the AI framework.

(10) The method according to any one of features (6) -(9), in which the third application is external to the RIC, and the first application communicates with the third application via an O-RAN R1 interface.

(11) The method according to any one of the features (6) -(10), in which the list of services provided by the AI framework specifies at least one of a (i) model and inference hosting service, (ii) model training and hosting service, (iii) model repository service, or (iv) model management service.

(12) An apparatus executing a first application, including at least one memory configured to store computer program code; and at least one processor configured to access said at least one memory and operate as instructed by said computer program code, said computer program code including: first sending code configured to cause at least one of said at least one processor to send an application registration request to a second application provided in an open random access network (O-RAN) intelligent controller (RIC): first receiving code configured to cause at least one of said at least one processor to receive, from the second application in response to the application registration request, a registration response including an application ID associated with the first application: second sending code configured to cause at least one of said at least one processor to send, to the second application, a register service request that includes at least (i) the application ID associated with the first application, and (ii) a service profile of a service provided by an artificial intelligence (AI) framework containing a plurality of learning models; and second receiving code configured to cause at least one of said at least one processor to receive, from the second application in response to the register service request, a register service response including a service identifier associated with the service provided by the AI framework.

(13) The apparatus of feature (12), in which said computer program code further includes: third receiving code configured to cause at least one of said at least one processor to receive, from a third application external to the RIC, a subscription request including the service identifier associated with the service provided by the AI framework, and third sending code configured to cause at least one of said at least one processor to send, to the third application in response to the subscription request, a subscription response including at least service endpoints that enable the third application to use the service provided by the AI framework.

(14) The apparatus of feature (12) or (13), in which the first application is external to the RIC, and the first application communicates with the second application via an O-RAN R1 interface.

(15) The apparatus of feature (14), in which said computer program code further includes: fourth sending code configured to cause at least one of said at least one processor to send, prior to sending the application registration request, a bootstrap request to the second application, and fourth receiving code configured to cause at least one of said at least one processor to receive, from the second application, a bootstrap response including information regarding an application registration application programming interface (API).

(16) The apparatus according to any one of features (12) -(15), in which the service provided by the AI framework is one of a (i) model and inference hosting service, (ii) model training and hosting service, (iii) model repository service, or (iv) a model management service.

(17) An apparatus executing a first application external to an open random access network (O-RAN) intelligent controller (RIC), the apparatus including: at least one memory configured to store computer program code; and at least one processor configured to access said at least one memory and operate as instructed by said computer program code, said computer program code including: first sending code configured to cause at least one of said at least one processor to send, to a second application provided in an O-RAN intelligent controller (RIC), a service discovery request; first receiving code configured to cause at least one of said at least one processor to receive, from the second application in response to the service discovery request, a service discovery response including a list of services provided by an artificial intelligence (AI) framework containing a plurality of learning models; second sending code configured to cause at least one of said at least one processor to send, to a third application, a service subscriber request specifying a service included in the list of services; and second receiving code configured to cause at least one of said at least one processor to receive, from the third application in response to the service subscriber request, a service subscriber response providing information that enables the first application to use the service specified in the service subscriber request.

(18) The apparatus of feature (17), in which the list of services included in the service discovery response includes capability information of each service included in the list of services.

(19) The apparatus according to feature (17) or (18), in which the information that enables the first application to use the service specified in the service subscriber request includes one or more procedures regarding the use of the service.

(20) The apparatus according to any one of features (17) -(19), in which the information that enables the first application to use the service specified in the service subscriber request includes end points of the service in the AI framework.

What is claimed is:

1. A method performed in a processor executing a first application, the method comprising:
sending an application registration request to a second application provided in an open random access network (O-RAN) intelligent controller (RIC);
receiving, from the second application in response to the application registration request, a registration response including an application ID associated with the first application;
sending, to the second application, a register service request that includes at least (i) the application ID associated with the first application, and (ii) a service profile of a service provided by an artificial intelligence (AI) framework containing a plurality of learning models; and
receiving, from the second application in response to the register service request, a register service response including a service identifier associated with the service provided by the AI framework.

2. The method of claim 1, further comprising:
receiving, from a third application external to the RIC, a subscription request including the service identifier associated with the service provided by the AI framework; and
sending, to the third application in response to the subscription request, a subscription response including at least service endpoints that enable the third application to use the service provided by the AI framework.

3. The method of claim 1, wherein the first application is external to the RIC, and the first application communicates with the second application via an O-RAN R1 interface.

4. The method of claim 3, further comprising:
prior to sending the application registration request, sending a bootstrap request to the second application; and
receiving, from the second application, a bootstrap response including information regarding an application registration application programming interface (API).

5. The method of claim 1, wherein the service provided by the AI framework is one of a (i) model and inference hosting service, (ii) model training and hosting service, (iii) model repository service, or (iv) a model management service.

6. A method performed by a processor executing a first application external to an open random access network (O-RAN) intelligent controller (RIC), the method comprising:
sending, to a second application provided in an O-RAN intelligent controller (RIC), a service discovery request;
receiving, from the second application in response to the service discovery request, a service discovery response including a list of services provided by an artificial intelligence (AI) framework containing a plurality of learning models;
sending, to a third application, a service subscriber request specifying a service included in the list of services; and
receiving, from the third application in response to the service subscriber request, a service subscriber response providing information that enables the first application to use the service specified in the service subscriber request.

7. The method of claim 6, wherein the list of services included in the service discovery response includes capability information of each service included in the list of services.

8. The method of claim 6, wherein the information that enables the first application to use the service specified in the service subscriber request includes one or more procedures regarding the use of the service.

9. The method of claim 6, wherein the information that enables the first application to use the service specified in the service subscriber request includes end points of the service in the AI framework.

10. The method according to claim 6, wherein the third application is external to the RIC, and the first application communicates with the third application via an O-RAN R1 interface.

11. The method of claim 6, wherein the list of services provided by the AI framework specifies at least one of a (i) model and inference hosting service, (ii) model training and hosting service, (iii) model repository service, or (iv) model management service.

12. An apparatus executing a first application, comprising:
at least one memory configured to store computer program code; and
at least one processor configured to access said at least one memory and operate as instructed by said computer program code, said computer program code including:
first sending code configured to cause at least one of said at least one processor to send an application registration request to a second application provided in an open random access network (O-RAN) intelligent controller (RIC);
first receiving code configured to cause at least one of said at least one processor to receive, from the second application in response to the application registration request, a registration response including an application ID associated with the first application;
second sending code configured to cause at least one of said at least one processor to send, to the second application, a register service request that includes at least (i) the application ID associated with the first application, and (ii) a service profile of a service provided by an artificial intelligence (AI) framework containing a plurality of learning models; and
second receiving code configured to cause at least one of said at least one processor to receive, from the second application in response to the register service request, a register service response including a service identifier associated with the service provided by the AI framework.

13. The apparatus of claim 12, wherein said computer program code further includes:
third receiving code configured to cause at least one of said at least one processor to receive, from a third application external to the RIC, a subscription request including the service identifier associated with the service provided by the AI framework, and
third sending code configured to cause at least one of said at least one processor to send, to the third application in response to the subscription request, a subscription response including at least service endpoints that enable the third application to use the service provided by the AI framework.

14. The apparatus of claim 12, wherein the first application is external to the RIC, and the first application communicates with the second application via an O-RAN R1 interface.

15. The apparatus of claim 14, wherein said computer program code further includes:
fourth sending code configured to cause at least one of said at least one processor to send, prior to sending the application registration request, a bootstrap request to the second application, and
fourth receiving code configured to cause at least one of said at least one processor to receive, from the second application, a bootstrap response including information regarding an application registration application programming interface (API).

16. The apparatus of claim 12, wherein the service provided by the AI framework is one of a (i) model and inference hosting service, (ii) model training and hosting service, (iii) model repository service, or (iv) a model management service.

17. An apparatus executing a first application external to an open random access network (O-RAN) intelligent controller (RIC), the apparatus comprising:
at least one memory configured to store computer program code; and
at least one processor configured to access said at least one memory and operate as instructed by said computer program code, said computer program code including:
first sending code configured to cause at least one of said at least one processor to send, to a second application provided in an O-RAN intelligent controller (RIC), a service discovery request;
first receiving code configured to cause at least one of said at least one processor to receive, from the second application in response to the service discovery request, a service discovery response including a list of services provided by an artificial intelligence (AI) framework containing a plurality of learning models;
second sending code configured to cause at least one of said at least one processor to send, to a third application, a service subscriber request specifying a service included in the list of services; and
second receiving code configured to cause at least one of said at least one processor to receive, from the third application in response to the service subscriber request, a service subscriber response providing information that enables the first application to use the service specified in the service subscriber request.

18. The apparatus of claim 17, wherein the list of services included in the service discovery response includes capability information of each service included in the list of services.

19. The apparatus of claim 17, wherein the information that enables the first application to use the service specified in the service subscriber request includes one or more procedures regarding the use of the service.

20. The apparatus of claim 17, wherein the information that enables the first application to use the service specified in the service subscriber request includes end points of the service in the AI framework.
